(19) United States
(12) Patent Application Publication
(10) Pub. No.: US 2026/0154748 A1
(43) Pub. Date: Jun. 4, 2026

(54) SYSTEMS AND METHODS FOR CALCULATING NET FLOWS

(71) Applicant: THE PNC FINANCIAL SERVICES GROUP, INC., Pittsburgh, PA (US)

(72) Inventors: Vatsal PANDYA, Pittsburgh, PA (US); Stephanie Elizabeth RODGERS, Pittsburgh, PA (US); Arunkumar SUNDARRAJAN, Pittsburgh, PA (US)

(73) Assignee: THE PNC FINANCIAL SERVICES GROUP, INC., Pittsburgh, PA (US)

(21) Appl. No.: 19/459,080

(22) Filed: Jan. 26, 2026

Related U.S. Application Data
(62) Division of application No. 18/787,176, filed on Jul. 29, 2024.
(60) Provisional application No. 63/615,893, filed on Dec. 29, 2023.

(51) Int. Cl. G06Q 40/06

(52) U.S. Cl. CPC G06Q 40/06

(57) ABSTRACT

Methods, systems, apparatuses, and non-transitory computer readable media are provided for calculating a net amount of assets. The operations may include receiving data from a transmission server in communication with a plurality of input sources, sending the data to a database, transforming the data into normalized data elements, analyzing the normalized data, transmitting a notification to an administrative entity to provide at least one supplementary data element, transforming the at least one normalized data element that complies with the common data scheme into tabulated data, calculating a net flow associated with the received data, based on the tabulated data, and sending the net flow calculation and the tabulated data to at least one electronic device associated with an external entity.

### CROSS REFERENCE TO RELATED APPLICATION

This application claims the benefit of priority of U.S. Provisional Patent Application No. 63/615,893 filed on Dec. 29, 2023, the contents of which are incorporated herein by reference in their entirety.

### TECHNICAL FIELD

The present disclosure relates generally to systems and methods for calculating an inflow and an outflow of assets associated with an account.

### BACKGROUND

The present disclosure relates generally to systems and methods for calculating the amount of new assets at an institution at least on a daily basis. More specifically, the present disclosure relates to classifying various financial transactions as inflows or outflows and then applying a formula to determine the “net flow” of assets. Additionally, the present disclosure describes systems and methods for calculating business investments based on the amount of new assets associated with a given account.

There are numerous ways that institutions calculate the amount of net assets deposited into accounts. These methods may involve manually recognizing each transaction as an inflowing asset or an outflowing asset. Methods of calculating net assets may be automated such that estimates are only calculated when there are unknown variables, or calculations are done on a bi-weekly or monthly basis only. Not only is it necessary for institutions to keep track of the amount of net assets as a critical indicator of the health of the business, but it also important to track net assets on a smaller scale to increase productivity of those who manage financial accounts. When the net assets of a particular account can be associated with a particular manager, incentives may be calculated based on the manager's performance. Incentive calculation may encourage managers to increase their client development and maintenance of the accounts they oversee.

In the context of institutions that allow clients to move assets, net flows may be new assets deposited into an account or assets withdrawn or transferred from an account. Net flows may also be estimations of incoming or outgoing funds associated with indefinite balances of investment accounts. In some cases, transactions include cash advances, checks paid or received, contributions, direct deposits, deposits received, distributions, credit lines received or paid, rollovers, taxes withheld or reimbursed, transfer of assets, automated clearing house transactions, or wires.

Retrieving data from a plurality of sources may create difficulties in accurately calculating net flows daily. Various sources may send data in various forms that make it more difficult for the data to be compiled into a single usable format. Data from various sources may also use different coding and terminology to define certain transactions, which can create inconsistencies in systems designed to calculate data from multiple sources. There is a need to normalize data from all sources so that it can be uniformly travel through a single pathway.

### SUMMARY

The disclosed embodiments describe systems, methods, and non-transitory computer readable media for calculating net flows consisting of deposits or withdrawals in a financial account. For example, in some embodiments, a system for calculating a net amount of assets may comprise a memory storing a set of instructions and at least one processor configured to execute the set of instructions. The operations may comprise receiving data from a transmission server in communication with a plurality of input sources, sending the data to a database, transforming the data into normalized data elements using a data normalization model, analyzing the normalized data to identify at least one normalized data element that complies with a common data scheme, or to identify at least one normalized data element that does not comply with the common data scheme, transmitting a notification to an administrative entity to provide at least one supplementary data element to replace the at least one normalized data element that does not comply with the common data scheme, transforming the at least one normalized data element that complies with the common data scheme into tabulated data, calculating a net flow associated with the received data, based on the tabulated data, and sending the net flow calculation and the tabulated data to at least one electronic device associated with an external entity.

According to some embodiments, the at least one processor may be configured to process large amounts of data from different sources.

According to some embodiments, the data may relate to a transaction event.

According to some embodiments, the transaction event may include at least one of an action that causes an increase of assets or an action that causes a decrease of assets.

According to some embodiments, the transaction event may be identified with a unique code from each of the plurality of input sources.

According to some embodiments, the plurality of input sources may be clearing houses.

According to some embodiments, the tabulated data may be formatted as an aggregated fact table or a summary table.

According to some embodiments, the summary table may be displayed on a graphical user interface associated with the at least one electronic device of the external entity and may further include at least one of: total inflows, total outflows, total incentive flows, incentive values, gross values, or activity dates.

According to some embodiments, the common data scheme may be associated with identifying the transaction event data included in the net flow calculation.

According to some embodiments, the net flow may be a difference between an increase in assets and a decrease in assets.

According to some embodiments, the at least one processor may be further configured to calculate the net flow in real-time.

In another exemplary embodiment, a method for calculating a net amount of assets may comprise receiving data from a transmission server in communication with a plurality of input sources, extracting transaction event data from the data, determining whether the transaction event data complies with a common data scheme, organizing transaction event data elements associated with the transaction event data based on whether the transaction event data is compliant with the common data scheme, sending a notification to an administrative entity to provide at least one supplementary data element to replace at least one of the transaction event data elements that does not comply with the common data scheme, updating the transaction event data with the at least one supplementary data element, transforming the transaction event data that complies with the common data scheme into tabulated data, calculating a net flow associated with the received data, based on the tabulated data, and sending the net flow calculation and the tabulated data to at least one electronic device associated with an external entity.

According to some embodiments, the transaction event data that does not comply with the common data scheme may not possess all necessary fields to be transformed into tabulated data.

According to some embodiments, the transaction event may include at least one of an action that causes an increase of assets or an action that causes a decrease of assets.

According to some embodiments, the common data scheme may include aggregation rules and exceptions.

According to some embodiments, the plurality of input source may be clearing houses.

According to some embodiments, the transmission server may be configured to process large amounts of data from different sources.

According to some embodiments, the common data scheme may be configured to identify the transaction event data included in the net flow calculation.

According to some embodiments, the notification may request that the administrative entity update the transaction event data so that it complies with the common data scheme.

In another exemplary embodiment, a non-transitory computer readable medium may be provided. The non-transitory computer readable medium may comprise computer readable instructions that, when executed by at least one processor, may cause the at least one processor to perform operations for calculating a net amount of assets. The operations may comprise receiving data from a transmission server in communication with a plurality of input sources, extracting transaction event data from the data, storing the transaction event data in a database, determining whether the transaction event data complies with a common data scheme, organizing transaction event data elements associated with the transaction event data based on whether the transaction event data is compliant with the common data scheme, sending a notification to an administrative entity to provide at least one supplementary data element to replace at least one of the transaction event data elements that does not comply with the common data scheme, updating the transaction event data with at least one supplementary data element, transforming the transaction event data that complies with the common data scheme into tabulated data, calculating a net flow associated with the received data, based on the tabulated data, and sending the calculated net flow and the tabulated data to at least one electronic device associated with an external entity.

Throughout this disclosure the phrase “disclosed embodiments,” refers to examples of ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that the above and other aspects and their implementations are explanatory and exemplary only and will be described in greater detail in the drawings, the descriptions, and the claims.

### BRIEF DESCRIPTION OF FIGURES

The accompanying drawings, which are incorporated in and constitute a part of this specification, illustrate disclosed embodiments and, together with the description, serve to explain the disclosed embodiments. In the drawings:

FIG. 1A illustrates a schematic representation of the issue sought to be solved, where bank employees express a desire to review an amount of assets in the accounts they manage, consistent with disclosed embodiments.

FIG. 1B illustrates a schematic representation of an exemplary solution for calculating an amount of assets deposited into an account with the net flow system, consistent with disclosed embodiments.

FIG. 2 illustrates a diagram of an exemplary computer-implemented system for processing and calculating net flows, consistent with disclosed embodiments.

FIG. 3 is a schematic diagram of the data pathway in the net flow system, consistent with disclosed embodiments.

FIG. 4 is a schematic diagram of the feedback loop that occurs when the net flow system encounters data that does not comply with the common data scheme, consistent with disclosed embodiments.

FIG. 5 is an example of a net flows summary report from the perspective of an account advisor, consistent with disclosed embodiments.

FIG. 6 is an example of a net flows summary report from the perspective of a sales manager, consistent with disclosed embodiments.

FIG. 7 is a flowchart of an exemplary net flow process for calculating an amount of assets.

FIG. 8 is flowchart of an exemplary net flow process for calculating an amount of assets.

FIG. 9 is a flowchart of an exemplary net flow process for calculating an amount of assets.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims. Additionally, some of the described embodiments or elements thereof can occur or be performed simultaneously, at the same point in time, or concurrently.

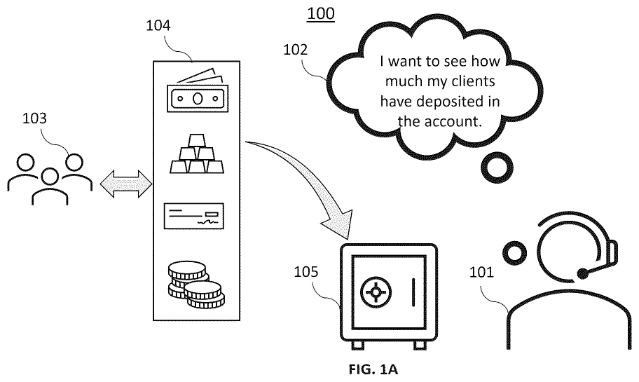

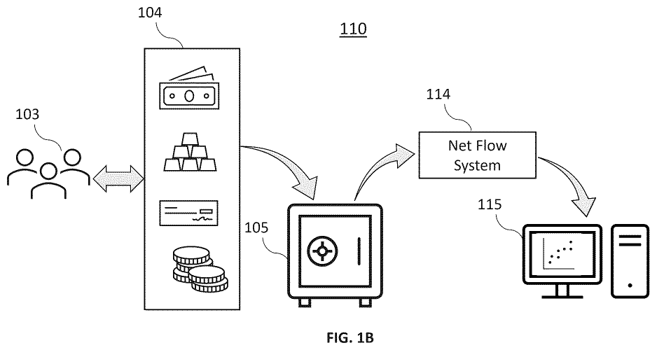

FIG. 1A illustrates a schematic representation of the issue sought to be solved 100, where account manager 101 expresses a desire to review an amount of assets 104 deposited by different sources 103 in the accounts 105 managed by account manager 101, consistent with disclosed embodiments. Account manager 101 is shown, with a thought bubble 102 that account manager 101 wants to know the amount of assets 104 that sources 103 have deposited into accounts 105 or withdrawn from accounts 105 managed by account manager 101. In the situation depicted in FIG. 1A, account manager 101 may not be able to track the flow of assets into and out of accounts 105 in real time because inflow and outflow data may be received from a variety of sources in a variety of formats. Accounts 105 managed by account manager 101 may receive dozens to hundreds of inflows and outflows each day, and the variety of data formats and sources may prevent account manager 101 from being able to identify the net flow of assets in real time. In some embodiments, net deposits may refer to the difference between the assets deposited into the account and the assets withdrawn from the account and may represent account net flows.

FIG. 1B illustrates a schematic representation of an exemplary solution 110 for calculating an amount of assets deposited into an account and/or withdrawn from an account using a net flow system 114, consistent with disclosed embodiments. FIG. 1B illustrates a net flows pathway in which sources 103 deposit assets 104 into accounts 105 and/or withdraw assets 104 from accounts 105. In some embodiments, a record of the deposits and/or withdrawals may then proceed through Net Flows System 114. Net Flow System 114 may calculate the net flow of an account (e.g., a difference between deposits of assets into the account and withdrawals of assets from the account) in real time and generate graphical report 115 available to an end user, such as account manager 101, as depicted in FIG. 1A. Graphical report 115 may display a net flow of assets 104 into and out of accounts 105 on a daily basis, which may allow account manager 101 to have an up-to-date record of the net flow of assets associated with accounts managed by account manager 101. Providing real-time records of the net flow of assets may allow account manager 101 to track productivity and performance in real time. For example, account manager 101 may review the real-time records of the net flow of assets to determine if account manager 101 will meet or exceed productivity and/or performance requirements.

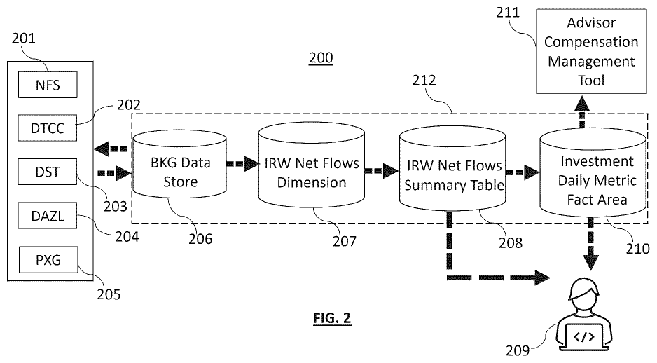

FIG. 2 is a schematic diagram of data pathway 200 for calculating net flows, consistent with disclosed embodiments. Data pathway 200 may receive inputs from a plurality of input sources. In some embodiments, an input source may include at least one of National Financial Switch (NFS) 201 (a network of shared automated teller machines (ATM's)), the Depository Trust and Clearing Corporation (DTCC) 202 (a financial market infrastructure organization that provides clearing, settlement, and trade reporting services), DST Asset Manager (DST) 203 (a financial services company), Data Access Zip Link (DAZL) 204 (an application providing access to current mutual fund and client account information), and Pershing (PXG) 205 (a business-to-business financial solutions provider, including a provider of clearinghouse services). Inputs from an input source may be received by a transmission server associated with data pathway 200 through a secure file transfer protocol. Each input from an input source may include transaction event data that may be captured and analyzed by data pathway 200. Transaction event data may include data associated with a transaction event, such as an inflow of assets into an account or an outflow of assets from an account. In some embodiments, the transaction event data may include data associated with a cash advance, check paid or received, contribution, direct deposit, deposit received, distribution, credit line received or paid, rollover, taxes withheld or reimbursed, transfer of assets, an automated clearing house transaction, and/or wire.

The transaction event data associated with inputs from the input sources may be transmitted to a brokerage (BKG) data store 206. BKG data store 206, IRW net flow dimension 207, IRW net flows summary table 208, and investment daily metric fact area 210 may comprise one or more computing device 212. Computing device 212 may be a variety of different types of computing devices capable of developing, storing, analyzing, and/or executing software code. For example, computing device 212 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 212 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 212 may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

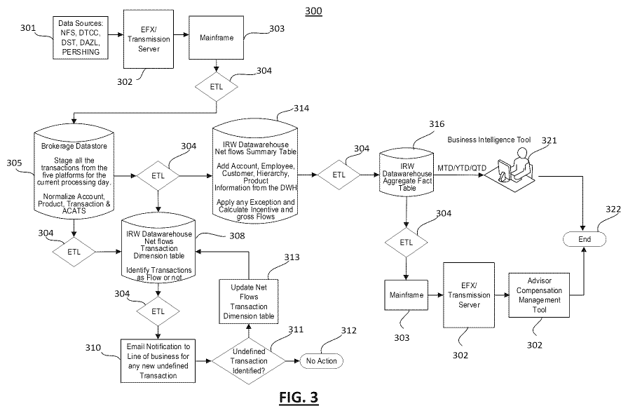

BKG data store 206 may include a data warehouse that may be focused on a particular subject or line of business. BKG data store 206 may allow for quicker and easier access to data because data does not need to be found in a larger, more complex data warehouse or aggregated from different sources. Transmitting transaction event data received from input sources to BKG data store 206 may ensure the transaction event data is collected and organized in a central, easily accessible location. BKG data store 206 may comprise staging tables, which may store daily raw transaction event data from the plurality of input sources in preparation for transformation. The staging tables of BKG data store 206 may comprise temporary staging tables that may accumulate the transaction event data received from the plurality of input sources. The staging tables may accumulate the history of transaction event data for periodic extracts (for example, using ETL tool 304, as disclosed herein with respect to FIG. 3, to extract transaction event data on an hourly, daily, monthly, etc. basis), may allow for loading and updating of large volumes of data from a plurality of input sources in batches without affecting other parts of BKG data store 206, and may create raw tables that can be transformed, cleaned, and normalized.

In some embodiments, the transaction event data stored in BKG data store 206 may be transformed into tabulated transaction event data. In some embodiments, tabulated transaction event data may be represented as summary tables. Summary tables may organize the raw transaction event data received from the input sources and stored in BKG data store 206 based on preset categories. Preset categories that may be used to organize the tabulated transaction event data may include, but are not limited to, inflows (such as deposits into an account), outflows (such as withdrawals from an account), Advisor (such as a financial advisor responsible for managing a plurality of client accounts), Regional Sales Manager (such as a mid-level manager responsible for managing financial advisors in a particular territorial region), and Territory Sales Executive (such as an upper-level manager responsible for managing Regional Sales Managers and Advisors in a particular territorial region) In further embodiments, tabulated data may organize and filter the raw transaction event data stored in BKG data store 206 according to the preset categorized described herein.

In some embodiments, the transaction event data in BKG data store 206 may be normalized. Normalizing transaction event data may comprise reorganizing the transaction event data to remove unstructured data and/or redundant data to create a standardized data format for the transaction event data. Normalizing transaction event data may further comprise creating one or more table and establishing relationships between the tables to eliminant redundancy and inconsistent dependency within the transaction event data. Normalizing the transaction event data may reduce computer resources that are needed to store the transaction event data by eliminating redundant data, which may improve the functionality of the databases that store the transaction event data. Normalizing the transaction event data may further provide a standardized data structure which may make it easier, faster, and more efficient to extract specific data or information from the normalized transaction event data.

The normalized transaction event data may be transmitted to Investment and Retirement (“IRW”) net flows dimension 207. IRW net flows dimension 207 may identify transactions found in the normalized transaction event data as “flow” or “excluded” data. “Flow” data may comprise assets that are deposited into an account or withdrawn from an account and are used to calculate the net flow of transactions, as disclosed herein. For example, in some embodiments, “flow” data may include cash advances, checks paid or received, contributions, direct deposits, deposits received, distributions, money line received or paid, rollovers, taxes withheld, transfers of assets, and/or wire transfers. “Excluded” data may comprise assets that may be deposited into an account or withdrawn from an account, but are not used to calculate the net flow of transactions. For example, in some embodiments, “excluded” data may comprise buying or selling stocks or bonds, corporate action, dividends, capital gains, interest, reinvestment, fees, and/or commissions. IRW net flows dimension 207 may remove “excluded” data from the normalized transaction event data because such data is not used to calculate net flow and may maintain “flow” data in the normalized transaction event data.

The filtered transaction event data from IRW net flows dimension 207 may be transmitted to IRW net flows summary table 208. IRW net flows summary table 208 may be used for internal reporting within an organization implementing data flow 200. For example, IRW net flows summary table 208 may comprise a database configured to store the filtered transaction event data so that the transaction event data can be aggregated by categories, such as product, advisor, territory sales executive, and regional sales manager. IRW net flows summary table 208 may contain details of every flow transaction associated with an advisor, regional sales manager, or territory executive. Accordingly, an advisor, regional sales manager, territory sales manager, or other user may be able to view the details of all flow transactions through IRW net flows summary table 208.

The filtered transaction event data may be further transformed into aggregated data tables. In some embodiments, aggregated data tables may be created by combining raw and tabulated datasets based on criteria to narrow the data down. Criteria for narrowing the data may include organizing data by the dates and time frames in which the transaction events took place, such as daily, monthly, quarterly, or yearly. In some embodiments, the summary tables and the aggregated data tables may be stored in the IRW net flows summary table 208 until they are sent to an external program, such as Business Intelligence Tool 209 or Advisor Compensation Management Tool 211, as depicted in FIG. 2.

In some embodiments, aggregated data tables and summary tables stored in IRW net flows summary table 208 may be sent directly to a reporting system where users of data pathway 200, such as advisors, regional sales managers, and/or territory executives, may review their performance through an external Business Intelligence Tool 209. In some embodiments, Business Intelligence Tool 209 may display to users the net flow totals for an adjustable period, including daily, quarterly, monthly, or yearly totals. In further embodiments, the Business Intelligence Tool 209 may allow users to filter data based on categories such as, inflows, outflows, Product, Advisor, Territory Sales Executive, and Regional Sales Manager. Business Intelligence Tool 209 may report data analysis as visualizations, for example by using Tableau or Oracle Business Intelligence Enterprise Edition (“OBIEE”). In some embodiments, data visualizations may include graphs, charts, and graphics that may visually summarize the data.

In other embodiments, aggregated data tables and summary tables from IRW net flows summary table 208 may be sent to investment daily metric fact area 210, before being transmitted to business intelligence tool 209. Investment daily metric fact area 210 may comprise a database configured to store aggregated data tables and summary tables. Here, the summary tables and the aggregated data tables may be reported internally within an organization employing data pathway 200 on a daily basis. In some embodiments, the summary tables and the aggregated data tables may first pass through internal reporting before being sent to an external program for further data analysis. The benefit of the summary tables and the aggregated data tables being reported to the investment daily metric fact area 210 first is so that users may see data regarding their performance more quickly. However, it is not necessary for the data to pass through the investment daily metric fact area 210 before proceeding to the Business Intelligence Tool 209, as illustrated in FIG. 2.

In some embodiments, the aggregated data tables may be transmitted to the investment daily metric fact area 210 before proceeding to Advisor Compensation Management Tool 211. Advisor Compensation Management Tool 211 may be an external program, such as Broadbridge, where user performance may be correlated with various incentives. Incentives may be correlated to user performance in a variety of methods, for example, users with high net flow totals may be awarded greater incentives or a higher quantity of incentives. In some embodiments, incentives may refer to financial awards. Advisor Compensation Management Tool 211 may display an employee's net inflows and net outflows for a total net flow of assets. The Advisor Compensation Management Tool 211 may further display incentives that may be received by the employee based on the employee's total net flow of assets. Advisor Compensation Management Tool 211 may provide an easily accessible platform to allow employees to view their performance and productivity and to view how their performance and productivity correlates to receiving financial incentives or bonuses.

FIG. 3 is a schematic diagram of net flow system 300, consistent with disclosed embodiments. Net flow system 300 may receive inputs from data sources 301. Data sources 301 may comprise financial management services, investment services, automated teller machine networks, clearing platforms, or other platforms or services related to financial management. For example, in some embodiments, data sources 301 may include one or more of NFS, DTCC, DST, DAZL, and/or Pershing. An input from data sources 301 may include transaction event data, which, in some embodiments, may correspond to a deposit into an account or a withdrawal from an account. Net flow system 300 may receive data from data sources 301 through a secure file transfer protocol. For example, transaction event data may be received by net flow system 300 at transmission server 302. Transmission server 302 may be configured to receive data, such as transaction event data, from a plurality of sources such as input sources 301. Transmission server 302 may further be configured to transmit data, such as the received transaction event data to mainframe 303. Mainframe 303 may comprise a server for storing and processing data, such as transaction event data transmitted from transmission server 302.

After transaction event data has been transmitted to and stored in mainframe 303, the transaction event data may be extracted, transformed, and loaded using extraction, transformation, and loading (“ETL”) tool 304. ETL tool 304 may be used throughout various steps of net flow system 300 to manipulate, analyze, and move transaction event data, as disclosed herein. For example, ETL tool 304 may extract data from the storage location holding the data, which may allow ETL tool to analyze how the data is stored and identify any security controls associated with the data. Because the transaction event data may contain secure personally identifiable information (PII) and other private financial data, the transaction event data may subject to security controls. The security controls may comprise safeguards to prevent, detect, or minimize security risks associated with storing and manipulating the transaction event data. For example, according to security controls associated with the transaction event data, ETL tool 304 may use encryption, authentication, authorization, and auditing techniques to enhance the security of the private transaction event data. ETL tool 304 may further transform the data after the data has been extracted from its storage location. In some embodiments, transformations of data may include modifying the data, normalizing the data, aggregating the data, removing duplicates from the data, sorting the data, merging data, inserting or deleting data, or any other forms of data transformation. After transforming data as necessary for use in net flow system 300, ETL tool 304 may load the transformed data into a destination system or storage location. For example, ETL tool 304 may transmit the transformed data for storage in a data warehouse or other storage locations or systems. In some embodiments, where transaction event data does not need to be transformed as part of net flow system 300, ETL tool 304 may store the transaction event data without transforming the transaction event data.

ETL tool 304 may extract transaction event data from mainframe 303 and transmit the transaction event data to BKG data store 305 for staging. BKG data store 305 may correspond to BKG data store 206, as disclosed herein with respect to FIG. 2. For example, BKG data store 305 may include a data warehouse that may be focused on a subject or line of business. BKG data store 305 may allow for quicker and easier access to data because data does not need to be found in a larger, more complex data warehouse or aggregated from different sources. BKG data store 305 may comprise staging tables, which may store daily raw transaction event data from the plurality of input sources 301 in preparation for transformation. The staging tables of BKG data store 305 may comprise temporary tables that may accumulate the transaction event data received from the plurality of input sources 301. The staging tables may accumulate the history of transaction event data for periodic extracts and may allow for loading and updating of large volumes of data from a plurality of input sources in batches without affecting other parts of BKG data store 305.

In some embodiments, the transaction event data may only be properly stored, manipulated, and analyzed by net flow system 300 if it includes all necessary data elements. For example, necessary data elements may include data corresponding to the Product, Advisor, Regional Sales Manager, or Firm level associated with each transaction. Therefore, ETL tool 304 may extract and transform the transaction event data stored in BKG data store 305 to normalize the data and identify missing and/or redundant data elements. ETL tool 304 may extract transaction event data from BKG data store 305 using optical character recognition (“OCR”) extraction for written or printed text and scanned documents, template-based data extraction using a predefined and reusable template scheme for particular data sets, AI-enabled data extraction using artificial intelligence models to extract different data sets from multiple sources, logical extraction using application programming interfaces (“API's”) to communicate with multiple types of software and operating systems, or any other forms or methods of data extraction techniques known to those of ordinary skill in the art.

ETL tool 304 may then normalize the extracted transaction event data. Normalizing the transaction event data may include reorganizing the transaction event data to remove unstructured data and/or redundant data to create a standardized data format for the transaction event data. For example, ETL tool 304 may create one or more tables and establish relationships between the tables to eliminant redundancy and inconsistent dependency within the transaction event data. ETL tool 304 may also update transaction event data (by using data dictionaries, metadata repositories, data mapping tools, etc.) to use standardized naming conventions and data types to make the transaction event data consistent and easier to manipulate. ETL tool 304 may further apply data cleansing techniques to normalize the transaction event data. For example, ETL tool may identify and/or replace missing values (for example, by replacing a missing value with a default value, average, or null), remove or merge duplicate values, and validate values against predefined rules or ranges to detect and correct any outlier data values. Normalizing the transaction event data may reduce computer resources that are needed to store the transaction event data by eliminating redundant data, which may improve the functionality of the databases that store the transaction event data. Normalizing the transaction event data may further provide a standardized data structure which may make it easier, faster, and more efficient to extract specific data or information from the normalized transaction event data. Such normalization may increase computing efficiency when analyzing and manipulating the transaction event data in net flow system 300.

In some embodiments, during normalization of transaction event data, ETL tool 304 may identify transaction event data that does not comply with a common data scheme of the organization implementing net flow system 300. For example, an organization implementing net flow system 300 may define a common data scheme that defines the types of transactions that are used to calculate the net flow of an account and the types of data fields that are required to be identified in the transaction event data. ETL tool 304 may identify transaction event data that includes missing or unidentified data values or transaction event data that should be excluded from the net flow calculation in accordance with the common data scheme. In such instances, ETL tool 304 may transmit the data sets containing missing or unidentified values to IRW data warehouse net flows transaction dimension table 308. IRW Net flows transaction dimension table 308 may correspond to IRW net flows dimension 207, as disclosed herein with respect to FIG. 2.

In some embodiments, the IRW net flows transaction dimension table 308 may store excluded transactions and data sets that may be missing necessary data elements. In some embodiments, excluded transactions may refer to transactions that do not comply with the aggregation rules, regulations, or exceptions of the common data scheme created by an institution utilizing the net flow system 300. For example, an investment account may accrue dividends that are immediately reinvested into the account. Although this action causes an increase in the assets in the account, an institution's common data scheme may be written such that reinvestment of dividends is excluded from the net flows calculation. Other examples of excluded transactions may be fees of any type, interests, journal entries, intra bank credits or debits, income, and adjustments. In some embodiments, data that is missing necessary data elements may not comply with the common data scheme. In further embodiments, data that contains unidentified transactions may not comply with the common data scheme.

The data stored in the IRW net flows transaction dimension table 308 may be processed through ETL tool 304 to analyze whether the data is compliant with a common data scheme. When ETL tool 304 identifies non-compliant data values (e.g., data values corresponding to an excluded transaction or unidentified data values) within the transaction event data, ETL tool 304 may generate an email notification 310 to a line of business. The email notification 310 may be sent to a line of business (e.g., an administrative entity, institution, or organization utilizing net flow system 300) to identify or correct the data. Other forms of notifications, such as text messages, phone calls, push notifications, or the like, may be generated in place of an email notification 310. At block 311, a line of business may either identify an undefined transaction or may not identify an undefined transaction within the transaction event data. When a line of business corrects data containing unidentified transactions, the system may update the net flows transaction dimension table 313 contained in the IRW net flows transaction dimension table 308. In some embodiments, data may be sent to the line of business that does not contain any unidentified transactions 311. When this occurs, no action 312 may be taken and the datasets stored in IRW net flows transaction dimension table 308 may not need to be updated. The updated data from the IRW net flows transaction dimension table 308 may then proceed through ETL tool 304 and be transmitted to IRW warehouse net flows summary table 314, as disclosed herein.

In some embodiments, if data in the BKG data store 305 complies with the common data scheme set by the organization implementing net flow system 300 and does not contain unidentified transaction event data values, then ETL tool 304 may extract such transaction event data from BKG data store 305, normalize the transaction event data as disclosed herein, and transmit the transaction event data directly to IRW data warehouse net flows summary table 314.

ETL tool 304 may then transform the transaction event data from BKG data store 305 and the updated transaction event data from the IRW net flows transaction dimension table 308 into tabulated data. The tabulated data may be stored in the IRW net flows summary table 314. The tabulated data may include summaries of the transformed data. For example, the tabulated data stored in IRW net flows summary table 314 may compile the normalized data from all transactions that meet the common data scheme of the organization implementing net flow system 300. In some embodiments, transforming the transaction event data to comply with the common data scheme may include adding account information (such as an account number of the account associated with the transaction event), employee information (such as an identification of the employee, such as the advisor responsible for the account associated with the transaction event), customer information (such as an identification of the customer associated with the account), a hierarchy (such as the regional sales manager and/or territory executive responsible for the advisor that manages the account associated with the transaction event), and product information (such as an identification of the type of account associated with the transaction event, such as a checking or savings account). In some embodiments, the transaction event data may be identified with a unique code from the plurality of input sources. Each unique code may be associated with the account information, employee information, customer information, hierarchy information, and product information. ETL tool 304 may add the aforementioned information to IRW net flows summary table 314 based on the corresponding unique code associated with the transaction event data.

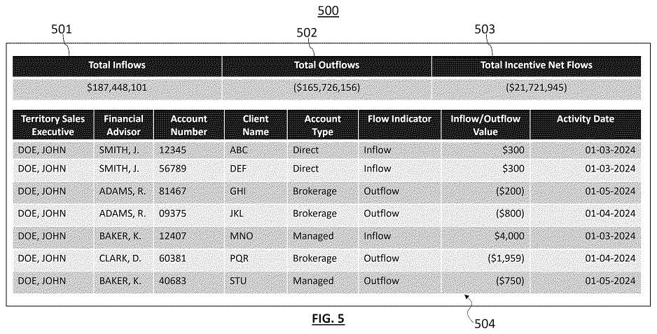

The tabulated data may list details of every transaction identified through net flow system 300 and may be used to populate a net flows detail dashboard, such as net flows summary report 500 as disclosed herein with respect to FIG. 5. The tabulated data, in the form of a summary table, may be used for internal reporting and may store the daily data in a way that can used to aggregate the total asset amounts by categories including but not limited to Product, Advisor, Regional Sales Manager, or Firm level for any given time period. ETL tool 304 may also calculate gross net flows by subtracting the total amount of outflows from the total amount of inflows. ETL tool 304 may also calculate “incentive” net flows, as disclosed herein, by subtracting the total amount of outflows and excluded transactions from the total amount of inflows. In some embodiments, the calculated data may be used to populate the aforementioned summary table within the IRW net flows summary table 314.

ETL tool 304 may then transform the summary tables into aggregated data tables that may provide cumulative net flow data. The aggregated data tables may include the net flow calculation totals on a monthly, yearly, and quarterly basis. While the summary tables stored in IRW net flows summary table 314 may include details of every transaction event identified through net flow system 300, the aggregated data tables may only contain a cumulative amount of each transaction on a monthly, quarterly, or yearly basis. After aggregating the transaction data from the summary tables into the aggregate tables, ETL tool 304 may load the aggregated data tables into the IRW data warehouse aggregate fact table 316 for storage. IRW data warehouse aggregate fact table 316 may comprise a central table in a data warehouse dimensional data model that may store quantitative business data, such as net flow calculations as disclosed herein. For example, the fact table may be at the center of a dimensional model, surrounded by multiple dimension tables. Each dimension table may contain a set of related information or attributes that describe the facts, or quantitative information, in the fact table. For example, the aggregated net flow values may be stored in IRW data warehouse aggregate fact table 316 and surrounding dimension tables may contain details about the net flow values, such as account information, advisor, regional sales manager, territory executive, dates, and other information associated with the aggregated net flow values. IRW data warehouse aggregate fact table 316 may provide a consolidated view of the quantitative data, such as the aggregated net flow values, which may optimize the quantitative data for querying, reporting, and analytics.

In some embodiments, the aggregated data tables stored in the IRW data warehouse aggregate fact table 316 may be sent to a reporting system where users may review their performance through a Business Intelligence Tool 321. Business Intelligence Tool 321 may correspond to Business Intelligence Tool 209, as disclosed herein with respect to FIG. 2. Business Intelligence Tool 321 may comprise a software application, platform, or solution that may process and display data. For example, Business Intelligence Tool 321 may provide a graphical user interface that a user may interact with to view net flow totals for an adjustable period of time, including quarterly, monthly, and yearly totals. Business Intelligence Tool 321 may receive the aggregated data tables stored in the IRW data warehouse aggregate fact table 316 and display the data values stored in the aggregated data tables for viewing by a user.

The aggregate data tables stored in the IRW data warehouse aggregate fact table 316 and the summary data tables stored in IRW data warehouse net flows summary tables 314 may be processed through ETL tool 304. For example, ETL tool 304 may transform the aggregate data tables and the summary into data formats that are compatible with external programs. The ETL tool 304 may then load the transformed data into mainframe 303 for storage. The transformed data may then be sent to transmission server 302. Transmission server 302 may transmit the data to external programs, such as Advisor Compensation Management Tool 320. Advisor Compensation Management Tool 320 may comprise a software application, platform, or solution that may provide reporting to a user, such as an advisor, regional sales manager, or territory executive, about performance and productivity. For example, a user's net flow of assets may correlate to the user's job performance and productivity statistics. An organization implementing net flow system 300 may have incentive programs that may reward an employee that performs to predetermined productivity levels. For example, an organization may analyze a user's overall net flow values during a given time period (e.g., daily, monthly, quarterly, yearly) and may provide incentives, such as bonuses or other rewards, if a user's net flow during the given time period meets a predetermined threshold level. Advisor Compensation Management Tool 320 may analyze the net flows provided in the summary tables and aggregate tables to determine if a particular user associated with the summary table and/or aggregate table falls below, meets, or exceeds predetermined productivity levels. Advisor Compensation Management Tool 320 may further calculate compensation and bonus amounts for a user based on the determination of how the user compared to the predetermined productivity levels. A user, such as an Advisor, Regional Sales Manager, or Territory Executive, may access Advisor Compensation Management Tool 320 to view detailed reports about performance and productivity. For example, reporting on user productivity may include a calculation of financial incentives the user qualifies for based on the net flow totals found in the summary tables and aggregate tables.

Net flow system 300 may end at end 322 after the aggregate data tables and summary tables have been transmitted to Business Intelligence Tool 321 and/or Advisor Compensation Management Tool 320.

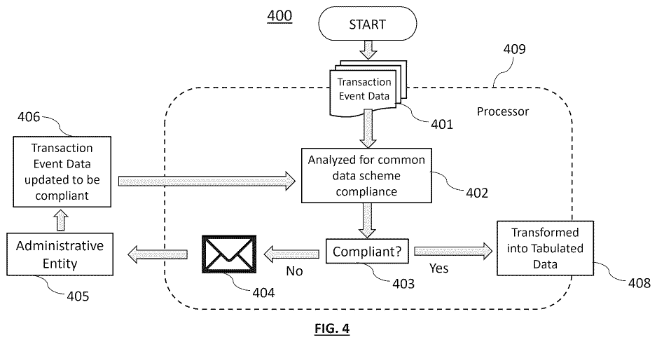

FIG. 4 is a schematic diagram of a feedback loop 400 that may occur as part of net flow system 300, as depicted in FIG. 3, when net flow system 300 encounters data that does not comply with the common data scheme, consistent with disclosed embodiments. A common data scheme may comprise a set of rules or a policy that may establish types of data that may be used by net flow system 300. For example, a common data scheme may define types of transaction data that may be categorized as “flow” data for the purpose of calculating net flow and types of transaction data that may be excluded from flow data when calculating net flow. The common data scheme may define transaction codes that may identify a type of transaction (e.g., interest, dividends, cash advance, direct deposits, etc.). The transaction codes of the common data scheme may be used to classify transaction event data of net flow system 300 as flow data or excluded data. The common data scheme may also define particular data fields that must be identified and provided in the transaction event data in order to analyze the transaction event data through net flow system 300. For example, the common data scheme may require that the transaction event data contain an identification of an advisor or regional sales manager or may require that the transaction event data contain client and account information.

Feedback loop 400 may begin when transaction event data 401 stored in the IRW data warehouse 308, as depicted in FIG. 3, is transmitted to at least one processor 409. In some embodiments, the at least one processor 409 may be associated with ETL tool 304, as disclosed herein with respect to FIG. 3. At block 402 of feedback loop 400, the at least one processor 409 may analyze the transaction event data 401 for compliance with the common data scheme. For example, analyzing the transaction event data 401 may comprise identifying a transaction code associated with the data values of the transaction event data 401 and/or determining if a data value of the transaction event data 401 does not have an associated transaction code.

At block 403 of feedback loop 400, processor 409 may categorize the transaction event data 401 as compliant or non-compliant. Compliant transaction event data 401 may comprise transaction event data that meets the rules or policies of the common data scheme associated with feedback loop 400 and net flow system 300, as disclosed herein with respect to FIG. 3. For example, compliant transaction event data may include data that is categorized with a transaction code associated with “flow” data. Non-compliant transaction event data 401 may comprise transaction event data that does not meet the rules or policies of the common data scheme associated with feedback loop 400 and net flow system 300. For example, non-compliant transaction event data may include data that is categorized with a transaction code associated with “excluded” data or may include data that is not categorized with a transaction code.

In some embodiments, if transaction event data 401 does not comply with the common data scheme, a notification 404 may be sent to an administrative entity 405. The notification may comprise an email, a text message, a phone call, a push notification, or any other form of notification. Notification 400 may include a transaction code, which may identify the transaction event data that does not comply with the common data scheme. Notification 400 may further include details of the transaction event data, such as the input source associated with the transaction event data. Administrative entity 405 may include a user associated with an organization implementing net flow system 300 or a user associated with input sources 301 (depicted in FIG. 3). At block 406 of feedback loop 400, administrative entity 405 may produce at least one supplementary data element to replace the at least one normalized data element that does not comply with the common data scheme. For example, administrative entity 405 may identify the transaction event associated with the transaction event data to classify the transaction event data as flow data or excluded data, as disclosed herein. Administrative entity 405 may further add the transaction code associated with the transaction event data to a transaction code dimension table, such as IRW net flows transaction dimension table 308 as depicted in FIG. 3, for incorporation into net flow system 300. Adding the transaction code to a transaction code dimension table may allow net flow system 300 to identify the same transaction code in later transaction event data. The transaction event data may then be transmitted to the IRW net flows transaction dimension table 308 (depicted in FIG. 3). At block 402 of feedback loop 400, the updated transaction event data may be analyzed for compliance with the common data scheme. At block 403 of feedback loop 400, the updated transaction event data 401 may then be re-categorized as compliant or non-compliant. If the updated transaction event data complies with the common data scheme, then the updated transaction event data may be transformed into tabulated data (as described in the aforementioned net flow system 300) at block 408 of feedback loop.

FIG. 5 is an example of a net flow summary report 500 displayed through a graphical user interface from the perspective of a financial advisor, consistent with disclosed embodiments. Net flow summary report 500 may comprise a report that may be viewable by a user through business intelligence tool 209 and/or advisor compensation management tool 211, as disclosed herein with respect to FIG. 2. Net flows summary report 500 may include total inflows 501, total outflows 502, total incentive net flows 503, and table 504. The first column, listed as total inflows 501, describes the total amount of assets that have been deposited in an account. The second column, listed as total outflows 502, describes the total amount of assets that have been withdrawn from an account. The third column listed as total incentive net flows 503 may refer to the difference between the total inflows 501 value and the total outflows 502 value excluding certain transactions according to the common data scheme, as disclosed herein. Excluded transactions may include but are not limited to transactions identified as outflows that are associated with an account that has had a change in management or account managers that have relationships with other institutions. Total inflows 501, total outflows 502, and total incentive net flows 503 may be associated with data from aggregate tables generated through net flow system 300, as disclosed herein with respect to FIG. 3. For example, total inflows 501, total outflows 502, and total incentive net flows 503 may comprise data stored in IRW data warehouse aggregate fact table 316 (as depicted in FIG. 3).

Table 504 may comprise a plurality of columns, including columns associated with a territory sales executive, financial advisor, account number, client name, account type, flow indicator, incentive value, and/or activity date. Table 504 may display details of individual transactions. For example, table 504 may display inflow and/or outflow values associated with individual transactions. Table 504 may be associated with data from IRW net flows summary table 314, as disclosed herein with respect to FIG. 3. For example, table 504 may display data associated with individual transactions that may be stored in IRW net flows summary table 314.

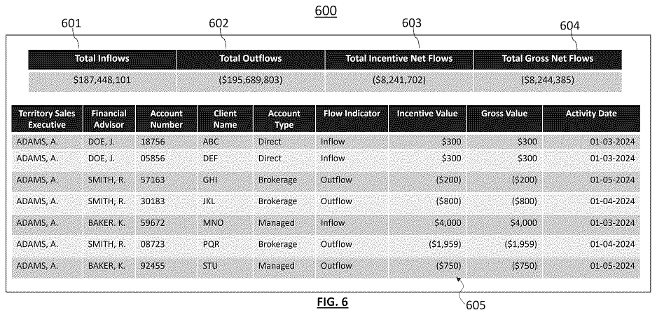

FIG. 6 is an example of a net flows summary report 600 displayed through a graphical user interface from the perspective of a sales manager, consistent with disclosed embodiments. A sales manager may manage a group of financial advisors and may view net flow summary report 600 to determine the performance of the financial advisors managed by the sales manager. Net flows summary report 600 may include total inflows 601, total outflows 602, total incentive net flows 603, total gross net flows 604, and table 605. The first column, listed as total inflows 601, may display a total amount of assets that have been deposited in a group of accounts associated with the sales manager viewing net flows summary report 600. For example, total inflows may aggregate an amount of assets deposited into a group of accounts associated with financial advisors managed by the sales manager viewing net flows summary report 600. The second column, listed as total outflows 602, may display a total amount of assets that have been withdrawn from a group of accounts associated with the sales manager viewing net flows summary report 600. For example, an outflow may be recorded and displayed when clients of financial advisors managed by a sales manager transfer assets to a different institution. The third column listed as total incentive net flows 603 may display the difference between the total inflows 601 value and the total outflows 602 value excluding certain transactions. Excluded transactions may include but are not limited to transactions identified as outflows that are associated with an account that has had a change in management or account managers that have relationships with other institutions. The fourth column listed as total gross net flows 604 may display the difference between the total inflows 601 value and the total outflows 602 value with no adjustments. Total inflows 601, total outflows 602, total incentive net flows 603, and total gross net flows 604 may be associated with data from aggregate tables generated through net flow system 300, as disclosed herein with respect to FIG. 3. For example, total inflows 601, total outflows 602, total incentive net flows 603 and total gross net flows 604 may display data that is stored in IRW data warehouse aggregate fact table 316 (as depicted in FIG. 3).

In some embodiments, an organization utilizing the net flows summary report 600 of FIG. 6 may provide incentives to employees for meeting certain predetermined thresholds, reaching a predetermined productivity level, or meeting predetermined milestones. For example, such an organization may provide a financial incentive or reward if an employee manages client account that meet or exceed certain threshold financial values. Specifically, if the net inflow of assets is greater than the net outflow of assets in a client account, then an organization may provide an incentive to the employee managing the client account. When determining the net flow of assets that may be used to calculate an incentive, certain inflow or outflow values may be excluded from the calculation based on the organization's incentive policy. Accordingly, total incentive net flows 603 column may display the adjusted net flow of assets according to the inflow or outflow values that are considered by the incentive policy. The total gross net flows 604 column may display the total net flow of assets without any adjustments made based on the organization's incentive policy. Displaying the total incentive net flows 603 and the total gross net flows 604 may allow a user viewing net flows summary report 600 to quickly and easily understand the user's incentive status with the organization.

Net flows summary report 600 may also include table 605. Table 605 may include columns such as territory sales executive, financial advisor, account number, client name, account type, flow indicator, incentive value, gross value, and activity date. Table 605 may be associated with data from summary tables generated through net flow system 300, as disclosed herein with respect to FIG. 3. For example, table 605 may display data that is stored in IRW data warehouse net flows summary table 314 (as depicted in FIG. 3). Table 605 may display the details of individual transactions to provide transparency to a user viewing net flows summary report 600 regarding the transactions that are used to calculate the aggregate amounts.

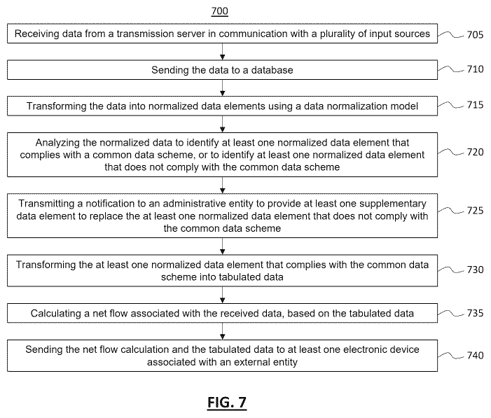

FIG. 7 is a flowchart of an exemplary net flow process 700 for calculating an amount of assets. Step 705 of net flow process 700 may include receiving data from a transmission server in communication with a plurality of input sources. The plurality of input sources may correspond to input sources 301 and the transmission server may correspond to transmission server 302, as disclosed herein with respect to FIG. 3. In some embodiments, input sources may include sources that may deposit assets into an account or withdraw assets from an account. In other embodiments, input sources may include clearing houses. A clearing house may include an entity or organization that validates and finalizes financial transaction. The clearing house may act as an intermediary between two parties in a financial transaction to facilitate the exchange of payments, securities, and/or derivatives. For example, input sources may include one or more of NFS, DTCC, DST, DAZL, and/or Pershing. Data received from the plurality of input sources may include data related to a transaction event, which may correspond to a deposit into an account or a withdrawal from an account. In some embodiments, a transaction event may include at least one of an action that causes an increase of assets (e.g., a deposit into an account) or an action that causes a decrease of assets (e.g., a withdrawal from an account). The transmission server may receive input data from data sources through a secure file transfer protocol.

Step 710 of net flow process 700 may include sending the data to a database. Sending the data to a database may comprise extracting the transaction event data from a mainframe, such as mainframe 303 as depicted in FIG. 3, and transmitting the transaction event data to a data store, such as BKG data store 305 as depicted in FIG. 3, for staging. The database may store the raw transaction event data that has not been processed or manipulated. For example, the transaction event data may be stored in staging tables of a BKG data store 305, which may comprise temporary tables that may accumulate the transaction event data received from the plurality of input sources. The staging tables may accumulate the history of transaction event data for periodic extracts, may allow for loading and updating of large volumes of data from a plurality of input sources in batches without affecting other parts of the BKG data store 305, and may create raw tables that can be transformed, cleaned, and normalized.

Step 715 of net flow process 700 may include transforming the data into normalized data elements using a data normalization model. Normalizing transaction event data may comprise reorganizing the transaction event data to remove unstructured data and/or redundant data to create a standardized data format for the transaction event data. Normalizing transaction event data may further comprise creating one or more table and establishing relationships between the tables to eliminant redundancy and inconsistent dependency within the transaction event data. Normalizing the transaction event data may reduce computer resources that are needed to store the transaction event data by eliminating redundant data, which may improve the functionality of the databases that store the transaction event data. Normalizing the transaction event data may further provide a standardized data structure which may make it easier, faster, and more efficient to extract specific data or information from the normalized transaction event data.

Step 720 of net flow process 700 may include analyzing the normalized data to identify at least one normalized data element that complies with a common data scheme, or to identify at least one normalized data element that does not comply with the common data scheme. In some embodiments, a common data scheme may refer to aggregation rules, regulations, or exceptions created by an institution utilizing net flow process 700. The common data scheme may identify transaction event data that may be included in a net flow calculation (e.g., a difference between net inflow and net outflow) and transaction event data that may be excluded from the net flow calculation. For example, an investment account may accrue dividends that are immediately reinvested into the account. Although this action causes an increase in the assets in the account, the common data scheme may be written such that reinvestment of dividends is excluded from the net flows calculation.

In some embodiments, the transaction event data may be identified with a unique code from the plurality of input sources. Each unique code may be associated with a transaction type. For example, the transaction event data may be categorized by codes that may correspond to transaction types, such as cash advance, checks paid, direct deposits, rollovers, taxes withheld, dividends, fees, interest, commission, and the like. The plurality of input sources may apply the unique codes to the transaction event data, which may allow net flow process 700 to analyze the normalized data to identify normalized data elements that do or do not comply with the common data scheme. For example, at Step 720, net flow process 700 may determine whether the unique code assigned to a transaction event data value is a flow value or an excluded value. If the transaction event data value is a flow value, then that transaction event data value may be included in calculating a net flow, as disclosed herein. If the transaction event data value is an excluded value, then that transaction event data may be excluded from a net flow calculation, as disclosed herein.

In some embodiments, the common data scheme may further specify particular data types that must be included in the transaction event data in order for the transaction event data to be used in the net flow calculation. For example, the common data scheme may require that the transaction event data include data associated with an identification of a territory sales executive, a regional sales manager, and a financial advisor associated with the transaction event. The common data scheme may further require that the transaction event data includes at least one of an account number, client name, account type, flow indicator (e.g., inflow or outflow), incentive value, and activity date associated with the transaction event. If the transaction event data received at step 705 of net flow process 700 does not include any of the required data fields, then the transaction event data may be determined to not comply with the common data scheme. If the transaction event data received at step 705 of net flow process 700 does include all the required data fields of the common data scheme, then the transaction event data may be determined to be in compliance with the common data scheme.

Step 725 of net flow process 700 may include transmitting a notification to an administrative entity to provide at least one supplementary data element to replace the at least one normalized data element that does not comply with the common data scheme. Sending a notification may comprise sending an email, a text message, a push notification, or any other form of notification to the administrative entity. The administrative entity may comprise an entity associated with the organization implementing net flow process 700 or any entity associated with an input source. The notification to the administrative entity may indicate that the transaction event data does not comply with the common data scheme and that one or more data fields of the transaction event data may require supplementary data. Supplementary data may be new or updated data associated with a data field of the transaction event data. Once the administrative entity receives the notification, the administrative entity may update the transaction event data such that it complies with the common data scheme. For example, if the transaction event data was missing a required data field, then the administrative entity may provide the missing required data field. If the transaction event data included an incorrect data field, then the administrative entity may replace the incorrect data field with a correct data value.

Step 730 of net flow process 700 may include transforming the at least one normalized data element that complies with the common data scheme into tabulated data. Transforming the transaction event data into tabulated data may comprise organizing the transaction event data into a table that may contain the data fields associated with the transaction event data. Transforming the event data into tabulated data may allow net flow process 700 to more easily and quickly access the transaction event data for manipulation and/or analysis. In some embodiments, the tabulated data may be formatted as an aggregate fact table or as a summary table. An aggregate fact table may correspond to IRW data warehouse aggregate fact table 316, as disclosed herein with respect to FIG. 3. For example, an aggregate fact table may include an aggregate amount of inflows and outflows associated with an account, an advisor, a regional sales manager, or a territory sales executive. A summary table may correspond to IRW data warehouse net flows summary table 314, as disclosed herein with respect to FIG. 3. For example, a summary table may include details about every transaction event associated with an account an advisor, a regional sales manager, or a territory sales executive. The summary table may provide a transaction-by-transaction summary of all transaction event data that complies with the common data scheme while the aggregate table may provide a high-level overall aggregate of net inflows and net outflows.

Step 735 of net flow process 700 may include calculating a net flow associated with the received data, based on the tabulated data. A net flow calculation may refer to a difference between an increase in assets and a decrease in assets. The tabulated data may include data on inflows associated with an account and outflows associated with the account. The calculation of net flows may be accomplished by subtracting the outflows associated with the account from the inflows associated with the account to determine a net flow attribute of the electronic record. In some embodiments, step 735 of net flow process 700 may calculate the net flow in real-time. In such embodiments, net flow may be calculated as input data is received from input sources in real time. Calculating the net flow in real time may provide up-to-date information for users of net flow process 700, allowing users to understand the net inflows and net outflows associated with the accounts analyzed through net flow process 700 at any given time.

Step 740 of net flow process 700 may include sending the net flow calculation and the tabulated data to at least one electronic device associated with an external entity. An external entity may include business intelligence tool 209 and/or advisor compensation management tool 211, as disclosed herein with respect to FIG. 2. The external entity may use the tabulated data and the calculated at least one attribute to display performance statistics to users. For example, an advisor may view the net inflows and outflows associated with the tabulated data through a graphical user interface associated with the external entity. The graphical user interface may display at least one of total inflows, total outflows, total incentive flows, incentive values, gross values, and/or activity dates. In some embodiments, the graphical user interface may correspond to net flow summary report 500 as disclosed herein with respect to FIG. 5 or net flow summary report 600 as disclosed herein with respect to FIG. 6.

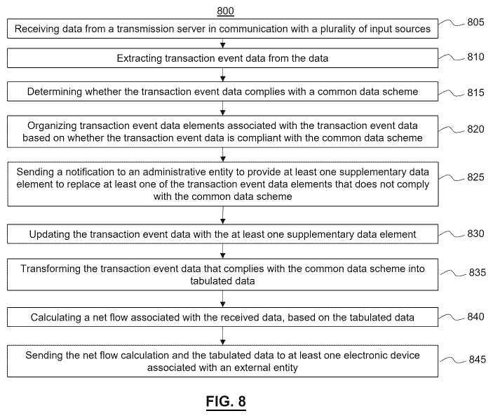

FIG. 8 is a flowchart of an exemplary net flow process 800 for calculating a net amount of assets. Step 805 of net flow process 800 may include receiving data from a transmission server in communication with a plurality of input sources. Step 805 of net flow process may correspond to step 705 of net flow process 700 as disclosed herein with respect to FIG. 7.

Step 810 of net flow process 800 may include extracting transaction event data from the data. Extracting transaction event data from the data received in step 805 of net flow process 800 may be accomplished using optical character recognition (“OCR”) extraction for written or printed text and scanned documents, template-based data extraction using a predefined and reusable template scheme for particular data sets, AI-enabled data extraction using artificial intelligence models to extract different data sets from multiple sources, logical extraction using application programming interfaces (“API's”) to communicate with multiple types of software and operating systems, or any other forms or methods of data extraction techniques.

Step 815 of net flow process 800 may include determining whether the transaction event data complies with a common data scheme. In some embodiments, a common data scheme may refer to aggregation rules, regulations, or exceptions created by an institution utilizing net flow process 800. The common data scheme may identify transaction event data that may be included in a net flow calculation (e.g., a difference between net inflow and net outflow) and transaction event data that may be excluded from the net flow calculation. For example, an investment account may accrue dividends that are immediately reinvested into the account. Although this action causes an increase in the assets in the account, the common data scheme may be written such that reinvestment of dividends is excluded from the net flows calculation.

In some embodiments, the transaction event data may be identified with a unique code from the plurality of input sources. Each unique code may be associated with a transaction type. For example, the transaction event data may be categorized by codes that may correspond to transaction types, such as cash advance, checks paid, direct deposits, rollovers, taxes withheld, dividends, fees, interest, commission, and the like. The plurality of input sources may apply the unique codes to the transaction event data, which may allow net flow process 800 to determine whether the transaction event data complies with the common data scheme. For example, at Step 815, net flow process 800 may determine whether the unique code assigned to a transaction event data value is a flow value or an excluded value. If the transaction event data value is a flow value, then that transaction event data value may be included in calculating a net flow, as disclosed herein. If the transaction event data value is an excluded value, then that transaction event data may be excluded from a net flow calculation, as disclosed herein.

In some embodiments, the common data scheme may further specify particular data types that must be included in the transaction event data in order for the transaction event data to be used in the net flow calculation. For example, the common data scheme may require that the transaction event data include data associated with an identification of a territory sales executive, a regional sales manager, and a financial advisor associated with the transaction event. The common data scheme may further require that the transaction event data includes at least one of an account number, client name, account type, flow indicator (e.g., inflow or outflow), incentive value, and activity date associated with the transaction event. If the transaction event data received at step 805 of net flow process 800 does not include any of the required data fields, then the transaction event data may be determined to not comply with the common data scheme. If the transaction event data received at step 805 of net flow process 800 does include all the required data fields of the common data scheme, then the transaction event data may be determined to be in compliance with the common data scheme.

Step 820 of net flow process 800 may include organizing transaction event data elements associated with the transaction event data based on whether the transaction event data is compliant with the common data scheme. Transaction event data elements may comprise individual units of data that may include distinct data values with specific attributes or fields within the transaction event data. For example, a transaction event data element may include data associated with an inflow value, an outflow value, a transaction date, an account number, a client name, an advisor, a regional sales manager, and/or a territory executive. Organizing the transaction event data elements associated with the transaction event data may comprise filtering the transaction event data based on whether the transaction event data is compliant with the common data scheme. The data elements may be organized in a database based on whether the transaction event data is associated with a unique code that identifies the transaction event data as flow data or excluded data. The data elements may also be organized in a database based on whether the transaction event data contains all the required data fields of the common data scheme. If the data does not contain all the required data fields of the common data scheme, then the non-compliant data fields may be filled with a normalized data element (e.g., an average, a predicted amount, a null value, etc.) to indicate that the non-compliant data field does not comply with the common data scheme.

Step 825 of net flow process 800 may include sending a notification to an administrative entity to provide at least one supplementary data element to replace at least one of the transaction event data elements that does not comply with the common data scheme. Step 825 of process 800 may correspond to step 725 of process 700, as disclosed herein with respect to FIG. 7.

Step 830 of net flow process 800 may include updating the transaction event data with the at least one supplementary data element. Updating the transaction event data may comprise replacing the at least one data element that is not compliant with the common data scheme with the at least one supplementary data element. The non-compliant data element may be removed and/or deleted from the transaction event data and the at least one supplementary data element may be added to the transaction event data as a replacement. Updating the transaction event data with the at least one supplementary data element may allow the transaction event data to comply with the common data scheme.

Step 835 of net flow process 800 may include transforming the transaction event data that complies with the common data scheme into tabulated data. Step 835 of net flow process 800 may correspond to step 730 of net flow process 700, as disclosed herein with respect to FIG. 7.

Step 840 of net flow process 800 may comprise calculating a net flow associated with the received data based on the tabulated data. Step 840 of net flow process 800 may correspond to step 735 of net flow process 700, as disclosed herein with respect to FIG. 7.

Step 845 of net flow process 800 may include sending the net flow calculation and the tabulated data to at least one electronic device associated with an external entity. Step 845 of net flow process 800 may correspond to step 740 of net flow process 700, as disclosed herein with respect to FIG. 7.

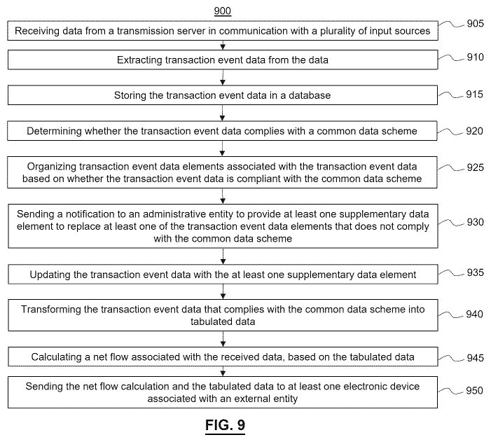

FIG. 9 is a flowchart of an exemplary net flow process 900 for calculating a net amount of assets. Step 905 of net flow process 800 may include receiving data from a transmission server in communication with a plurality of input sources. Step 905 of net flow process may correspond to step 705 of net flow process 700 as disclosed herein with respect to FIG. 7. Step 910 of net flow process 900 may include extracting transaction event data from the data. Step 910 of net flow process 900 may correspond to step 810 of net flow process 800, as disclosed herein with respect to FIG. 8. Step 915 of net flow process 900 may include storing the transaction event data in a database. Step 915 of net flow process 900 may correspond to step 710 of net flow process 700, as disclosed herein with respect to FIG. 7. Step 920 of net flow process 900 may include determining whether the transaction event data complies with a common data scheme. Step 920 of net flow process 900 may correspond to step 815 of net flow process 800, as disclosed herein with respect to FIG. 8. Step 925 of net flow process 900 may include organizing transaction event data elements associated with the transaction event data based on whether the transaction event data is compliant with the common data scheme. Step 925 of net flow process 900 may correspond to step 820 of net flow process 800 as disclosed herein with respect to FIG. 8. Step 930 of net flow process 900 may include sending a notification to an administrative entity to provide at least one supplementary data element to replace at least one of the transaction event data elements that does not comply with the common data scheme. Step 930 of net flow process 900 may correspond to step 725 of net flow process 700, as disclosed herein with respect to FIG. 7. Step 935 of net flow process 900 may include updating the transaction event data with the at least one supplementary data element. Step 935 of net flow process 900 may correspond to step 830 of net flow process 800 as disclosed herein with respect to FIG. 8. Step 940 of net flow process 900 may include transforming the transaction event data that complies with the common data scheme into tabulated data. Step 940 of net flow process 900 may correspond to step 835 of net flow process 800 as disclosed herein with respect to FIG. 8. Step 945 of net flow process 900 may include calculating a net flow associated with the received data, based on the tabulated data. Step 945 of net flow process 900 may correspond to step 840 of net flow process 800 as disclosed herein with respect to FIG. 8. Step 950 of net flow process 900 may include sending the net flow calculation and the tabulated data to at least one electronic device associated with an external entity. Step 950 of net flow process 900 may correspond to step 845 of net flow process 800 as disclosed herein with respect to FIG. 8.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1-11. (canceled)

12. A method for calculating a net amount of assets, the method comprising:
receiving data from a transmission server in communication with a plurality of input sources;
extracting transaction event data from the data;
determining whether the transaction event data complies with a common data scheme;
organizing transaction event data elements associated with the transaction event data based on whether the transaction event data is compliant with the common data scheme;
sending a notification to an administrative entity to provide at least one supplementary data element to replace at least one of the transaction event data elements that does not comply with the common data scheme;
updating the transaction event data with the at least one supplementary data element;
transforming the transaction event data that complies with the common data scheme into tabulated data;
calculating a net flow associated with the received data, based on the tabulated data; and
sending the net flow calculation and the tabulated data to at least one electronic device associated with an external entity.

13. The method of claim 12, wherein the transaction event data that does not comply with the common data scheme does not possess all necessary fields to be transformed into tabulated data.

14. The method of claim 12, wherein the transaction event includes at least one of an action that causes an increase of assets or an action that causes a decrease of assets.

15. The method of claim 12, wherein the common data scheme includes aggregation rules and exceptions.

16. The method of claim 12, wherein the plurality of input source are clearing houses.

17. The method of claim 12, wherein the transmission server is configured to process large amounts of data from different sources.

18. The method of claim 12, wherein the common data scheme is configured to identify the transaction event data included in the net flow calculation.

19. The method of claim 12, wherein the notification is requesting the administrative entity to update the transaction event data so that it complies with the common data scheme.

20. A non-transitory computer readable medium comprising computer readable instructions that, when executed by at least one processor, cause the at least one processor to perform operations for calculating a net amount of assets, the operations comprising:
receive data from a transmission server in communication with a plurality of input sources;
extract transaction event data from the data;
store the transaction event data in a database;
determine whether the transaction event data complies with a common data scheme;
organize transaction event data elements associated with the transaction event data based on whether the transaction event data is compliant with the common data scheme;
send a notification to an administrative entity to provide at least one supplementary data element to replace at least one of the transaction event data elements that does not comply with the common data scheme;
update the transaction event data with the at least one supplementary data element;
transform the transaction event data that complies with the common data scheme into tabulated data;
calculate a net flow associated with the received data, based on the tabulated data; and
send the calculated net flow and the tabulated data to at least one electronic device associated with an external entity.

21. The non-transitory computer readable medium of claim 20, wherein the transaction event data that does not comply with the common data scheme does not possess all necessary fields to be transformed into tabulated data.

22. The non-transitory computer readable medium of claim 20, wherein the transaction event includes at least one of an action that causes an increase of assets or an action that causes a decrease of assets.

23. The non-transitory computer readable medium of claim 20, wherein the common data scheme includes aggregation rules and exceptions.

24. The non-transitory computer readable medium of claim 20, wherein the plurality of input sources are clearing houses.

25. The non-transitory computer readable medium of claim 20, wherein the transmission server is configured to process large amounts of data from different sources.

26. The non-transitory computer readable medium of claim 20, wherein the common data scheme is configured to identify the transaction event data included in the calculated net flow.

27. The non-transitory computer readable medium of claim 20, wherein the notification is requesting the administrative entity to update the transaction event data so that it complies with the common data scheme.
